(19) United States
(12) Patent Application Publication
(10) Pub. No.: US 2011/0161868 A1
(43) Pub. Date: Jun. 30, 2011

(54) Management of windowing operating system utilizing monitored user behavior and preferences

(75) Inventors: Matthew John Green, Southport (AU); Grant Charles Murphy, Southport (AU)

(73) Assignee: International Business Machines Corporation, Armonk, NY (US)

(21) Appl. No.: 12/649,586

(22) Filed: Dec. 30, 2009

(51) Int. Cl. G06F 3/048

(52) U.S. Cl. 715/789

(57) ABSTRACT

An approach is provided that receives a user action directed at a first windowed application that is executing in a windowing operating system. The first windowed application is displayed on a display using a first set of display attributes. In response to receiving the user action, user preferences are retrieved that correspond to the first windowed application. The user preferences reference a second windowed application that runs in the windowed operating system. The second windowed application is displayed on the display using a second set of display attributes. One or more actions corresponding to the second windowed application are identified based on the retrieved user preferences. These identified actions are executed on the second windowed application and result in a change to the second set of display attributes which causes in a change in an appearance of the second windowed application.

### TECHNICAL FIELD

The present invention relates to an approach for managing windows within a windowing operating system based upon past user behaviors and stored preferences.

### BACKGROUND

Most modern operating systems provide a windows based user interface. This interface allows a user to have multiple applications open at the same time, and switch between, resize and minimize windows. When it comes to the arrangement of multiple windows, most operating systems provide the ability to minimize all windows, arrange windows in a tiled or cascaded perspective automatically. These operations are limited and generalized. They take little consideration of the applications optimal viewing perspective, the users preferred window size or how applications are being used together. When performing certain tasks it is sometimes preferable to have several windows open at the same time, and arranged in a specific way so that they can be seen all at once. Applying any of the aforementioned arrangement strategies, or opening another window forces the end user to reorganize how the open applications are arranged. This becomes an annoyance and effects the user experience. Another challenge in the current art is that the windowing systems are not dynamic enough to adjust without calling on user intervention. In traditional windowing operating systems, windows are self concerned and are adjust to direct stimulus to their window handle from the users peripheral input devices.

### SUMMARY

An approach is provided that receives a user action directed at a first windowed application that is executing in a windowing operating system. The first windowed application is displayed on a display using a first set of display attributes. In response to receiving the user action, user preferences are retrieved that correspond to the first windowed application. The user preferences reference a second windowed application that runs in the windowed operating system. The second windowed application is displayed on the display using a second set of display attributes. One or more actions corresponding to the second windowed application are identified based on the retrieved user preferences. These identified actions are executed on the second windowed application and result in a change to the second set of display attributes which causes in a change in an appearance of the second windowed application.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings, wherein:

FIG. 1 is a block diagram of a data processing system in which the methods described herein can be implemented;

FIG. 2 provides an extension of the information handling system environment shown in FIG. 1 to illustrate that the methods described herein can be performed on a wide variety of information handling systems which operate in a networked environment;

FIG. 3 is a high level flowchart showing interaction of the processes and data stores used to manage the windowing environment;

FIG. 4 is a flowchart showing steps taken by the system to manage and record the user's preferences;

FIG. 5 is a flowchart showing steps taken monitor the user's behavior;

FIG. 6 is a flowchart showing steps taken by the user experience decision engine process; and

FIG. 7 is a flowchart showing steps to control windows by performing actions identified by the user experience decision engine.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Certain specific details are set forth in the following description and figures to provide a thorough understanding of various embodiments of the invention. Certain well-known details often associated with computing and software technology are not set forth in the following disclosure, however, to avoid unnecessarily obscuring the various embodiments of the invention. Further, those of ordinary skill in the relevant art will understand that they can practice other embodiments of the invention without one or more of the details described below. Finally, while various methods are described with reference to steps and sequences in the following disclosure, the description as such is for providing a clear implementation of embodiments of the invention, and the steps and sequences of steps should not be taken as required to practice this invention. Instead, the following is intended to provide a detailed description of an example of the invention and should not be taken to be limiting of the invention itself. Rather, any number of variations may fall within the scope of the invention, which is defined by the claims that follow the description.

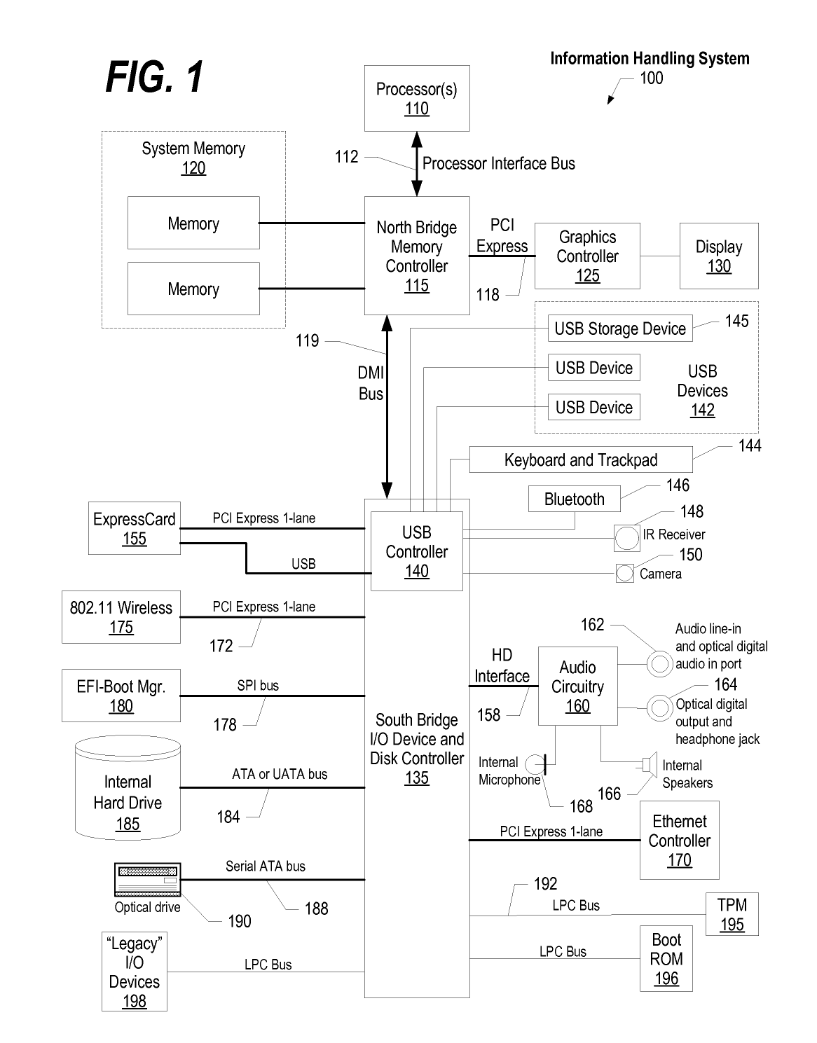

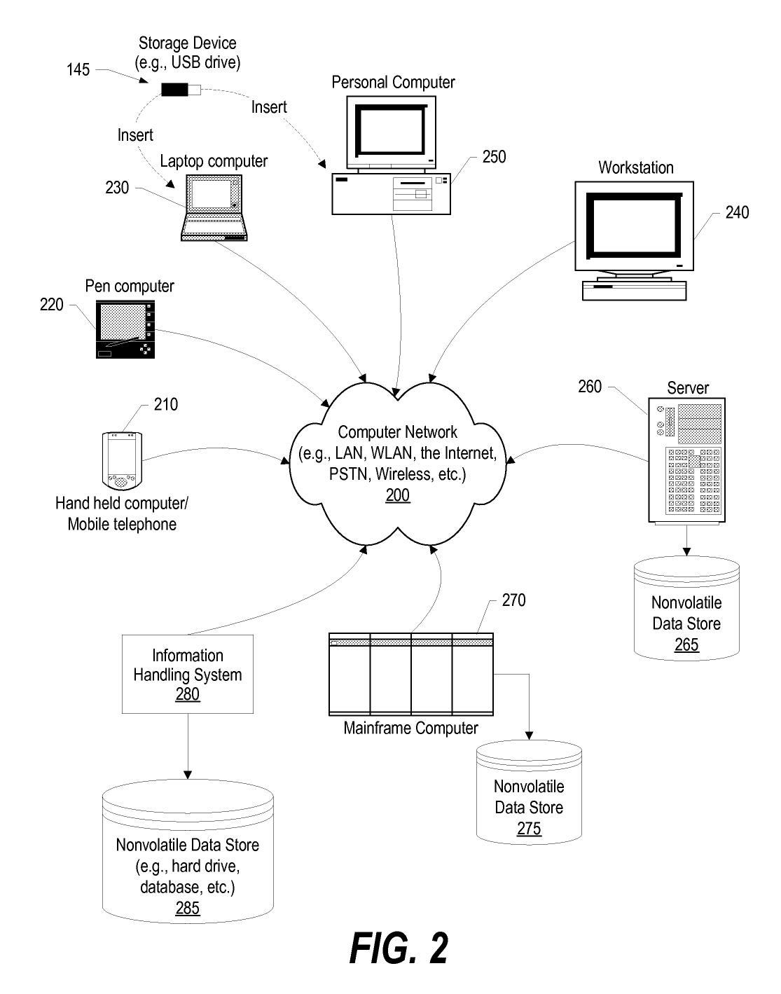

The following detailed description will generally follow the summary of the invention, as set forth above, further explaining and expanding the definitions of the various aspects and embodiments of the invention as necessary. To this end, this detailed description first sets forth a computing environment in FIG. 1 that is suitable to implement the software and/or hardware techniques associated with the invention. A networked environment is illustrated in FIG. 2 as an extension of the basic computing environment, to emphasize that modern computing techniques can be performed across multiple discrete devices.

FIG. 1 illustrates information handling system 100, which is a simplified example of a computer system capable of performing the computing operations described herein. Information handling system 100 includes one or more processors 110 coupled to processor interface bus 112. Processor interface bus 112 connects processors 110 to Northbridge 115, which is also known as the Memory Controller Hub (MCH). Northbridge 115 connects to system memory 120 and provides a means for processor(s) 110 to access the system memory. Graphics controller 125 also connects to Northbridge 115. In one embodiment, PCI Express bus 118 connects Northbridge 115 to graphics controller 125. Graphics controller 125 connects to display device 130, such as a computer monitor.

Northbridge 115 and Southbridge 135 connect to each other using bus 119. In one embodiment, the bus is a Direct Media Interface (DMI) bus that transfers data at high speeds in each direction between Northbridge 115 and Southbridge 135. In another embodiment, a Peripheral Component Interconnect (PCI) bus connects the Northbridge and the Southbridge. Southbridge 135, also known as the I/O Controller Hub (ICH) is a chip that generally implements capabilities that operate at slower speeds than the capabilities provided by the Northbridge. Southbridge 135 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 196 and “legacy” I/O devices (using a “super I/O” chip). The “legacy” I/O devices (198) can include, for example, serial and parallel ports, keyboard, mouse, and/or a floppy disk controller. The LPC bus also connects Southbridge 135 to Trusted Platform Module (TPM) 195. Other components often included in Southbridge 135 include a Direct Memory Access (DMA) controller, a Programmable Interrupt Controller (PIC), and a storage device controller, which connects Southbridge 135 to nonvolatile storage device 185, such as a hard disk drive, using bus 184.

ExpressCard 155 is a slot that connects hot-pluggable devices to the information handling system. ExpressCard 155 supports both PCI Express and USB connectivity as it connects to Southbridge 135 using both the Universal Serial Bus (USB) the PCI Express bus. Southbridge 135 includes USB Controller 140 that provides USB connectivity to devices that connect to the USB. These devices include webcam (camera) 150, infrared (IR) receiver 148, keyboard and trackpad 144, and Bluetooth device 146, which provides for wireless personal area networks (PANs). USB Controller 140 also provides USB connectivity to other miscellaneous USB connected devices 142, such as a mouse, removable nonvolatile storage device 145, modems, network cards, ISDN connectors, fax, printers, USB hubs, and many other types of USB connected devices. While removable nonvolatile storage device 145 is shown as a USB-connected device, removable nonvolatile storage device 145 could be connected using a different interface, such as a Firewire interface, etcetera.

Wireless Local Area Network (LAN) device 175 connects to Southbridge 135 via the PCI or PCI Express bus 172. LAN device 175 typically implements one of the IEEE 802.11 standards of over-the-air modulation techniques that all use the same protocol to wirelessly communicate between information handling system 100 and another computer system or device. Optical storage device 190 connects to Southbridge 135 using Serial ATA (SATA) bus 188. Serial ATA adapters and devices communicate over a high-speed serial link. The Serial ATA bus also connects Southbridge 135 to other forms of storage devices, such as hard disk drives. Audio circuitry 160, such as a sound card, connects to Southbridge 135 via bus 158. Audio circuitry 160 also provides functionality such as audio line-in and optical digital audio in port 162, optical digital output and headphone jack 164, internal speakers 166, and internal microphone 168. Ethernet controller 170 connects to Southbridge 135 using a bus, such as the PCI or PCI Express bus. Ethernet controller 170 connects information handling system 100 to a computer network, such as a Local Area Network (LAN), the Internet, and other public and private computer networks.

While FIG. 1 shows one information handling system, an information handling system may take many forms. For example, an information handling system may take the form of a desktop, server, portable, laptop, notebook, mobile internet device, or other form factor computer or data processing system. In addition, an information handling system may take other form factors such as a personal digital assistant (PDA), a gaming device, ATM machine, a portable telephone device, a communication device or other devices that include a processor and memory.

FIG. 2 provides an extension of the information handling system environment shown in FIG. 1 to illustrate that the methods described herein can be performed on a wide variety of information handling systems that operate in a networked environment. Types of information handling systems range from small handheld devices, such as handheld computer/mobile telephone 210 to large mainframe systems, such as mainframe computer 270. Examples of handheld computer 210 include personal digital assistants (PDAs), personal entertainment devices, such as MP3 players, portable televisions, and compact disc players. Other examples of information handling systems include pen, or tablet, computer 220, laptop, or notebook, computer 230, workstation 240, personal computer system 250, and server 260. Other types of information handling systems that are not individually shown in FIG. 2 are represented by information handling system 280. As shown, the various information handling systems can be networked together using computer network 200. Types of computer network that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems shown in FIG. 2 depicts separate nonvolatile data stores (server 260 utilizes nonvolatile data store 265, mainframe computer 270 utilizes nonvolatile data store 275, and information handling system 280 utilizes nonvolatile data store 285). The nonvolatile data store can be a component that is external to the various information handling systems or can be internal to one of the information handling systems. In addition, removable nonvolatile storage device 145 can be shared among two or more information handling systems using various techniques, such as connecting the removable nonvolatile storage device 145 to a USB port or other connector of the information handling systems.

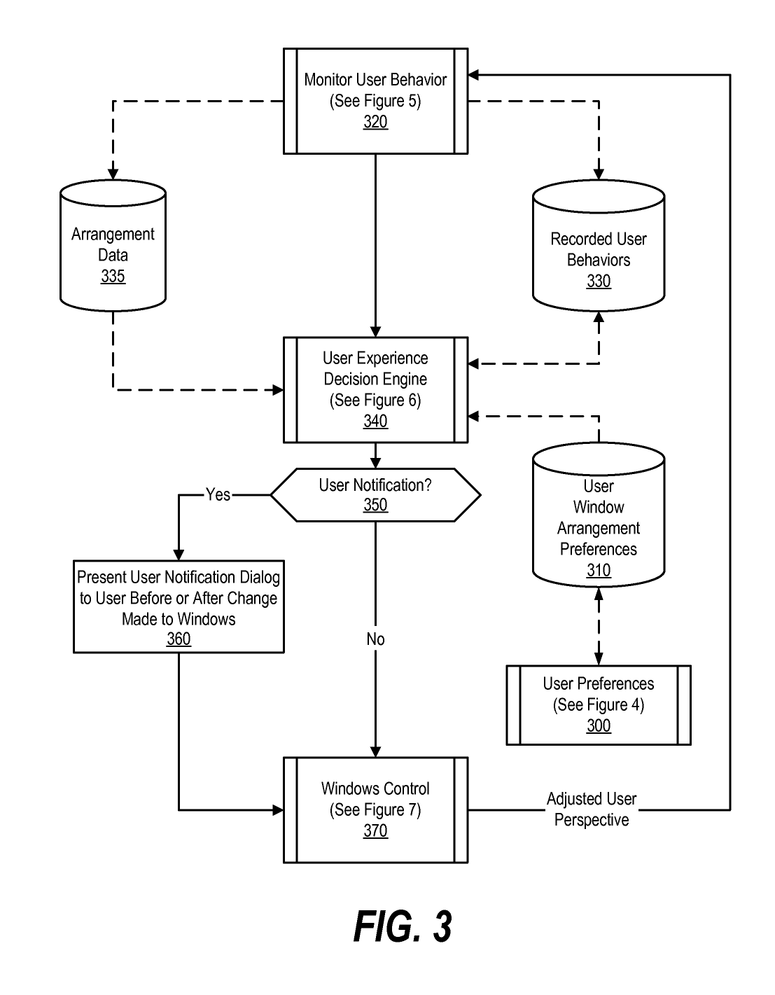

FIG. 3 is a high level flowchart showing interaction of the processes and data stores used to manage the windowing environment. The user enters one or more preferences as to how the user desires the system to operate, such as whether window arrangement should take place automatically and whether the user should be prompted before changes are made. User preferences are entered and edited through user preferences predefined process 300. The user's preferences are stored in user window arrangement preferences 310.

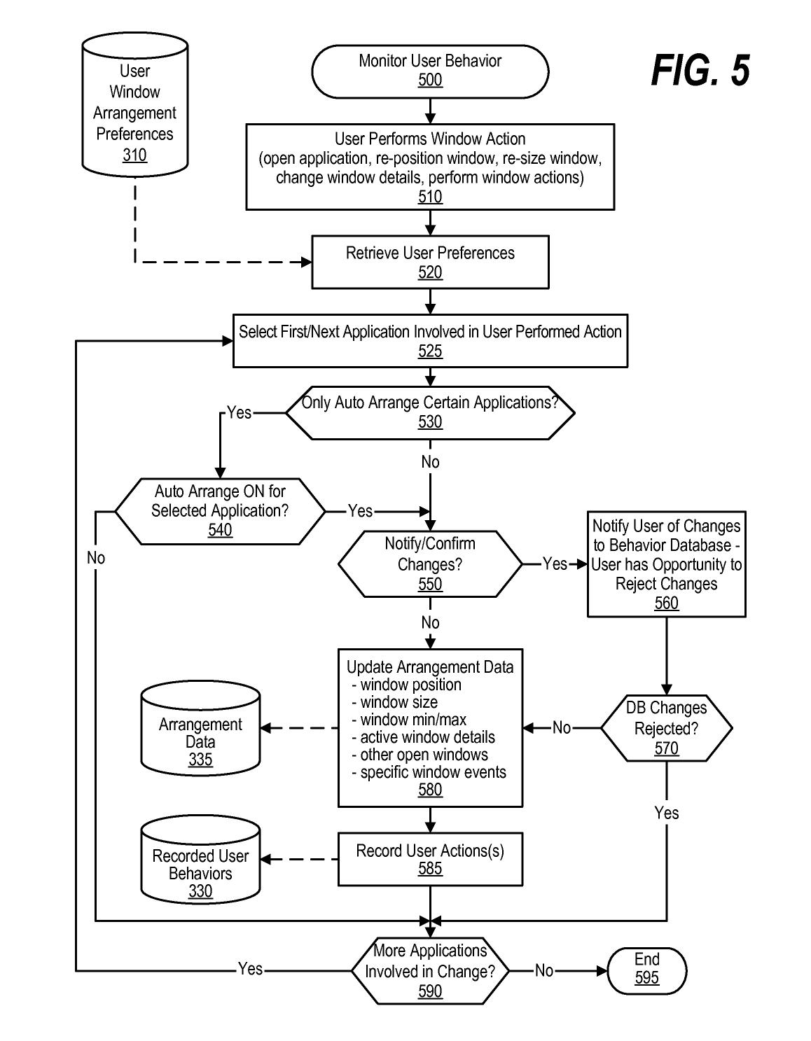

User behavior is monitored using predefined process 320 (see FIG. 5 and corresponding text for processing details). The user behaviors are recorded and stored in recorded user behaviors data store 330. User behaviors can track actions that a user performs on multiple windowed applications and correlates these actions to one another. For example, if the user opens an email windowed application and also opens an electronic calendar windowed application and positions the windowed applications side-by-side with the same height so that the calendar application is to the left of the email application, the user behavior is tracked and recorded in recorded user behavior 330. In addition, the arrangement of the windowed applications in relation to each other is recorded in arrangement data store 335. When the user subsequently uses the system and opens the email windowed application, the previously recorded user behaviors are read from data store 330 and the arrangement data of the two windowed applications is retrieved from arrangement data 335 so that the calendar windowed application can be automatically launched for the user and the application windows can be sized and positioned proximate to each other just like originally set up by the user (e.g., same height with calendar window left of the email window). Arrangement data corresponding to the various windowed applications executed in the windowing operating system is stored in data store 335. The arrangement data includes data that relates arrangement of multiple application windows, such as altering one or more window positions based on an activity in another window, altering one or more window sizes based on an activity in another window, minimizing one or more windows based on an activity in another window, maximizing one or more windows based on an activity in another window, altering window details of one or more windows based on an activity in another window, launching one or more windowed applications based on an activity in another window, and performing specific window events to one or more windows based on an activity in another window.

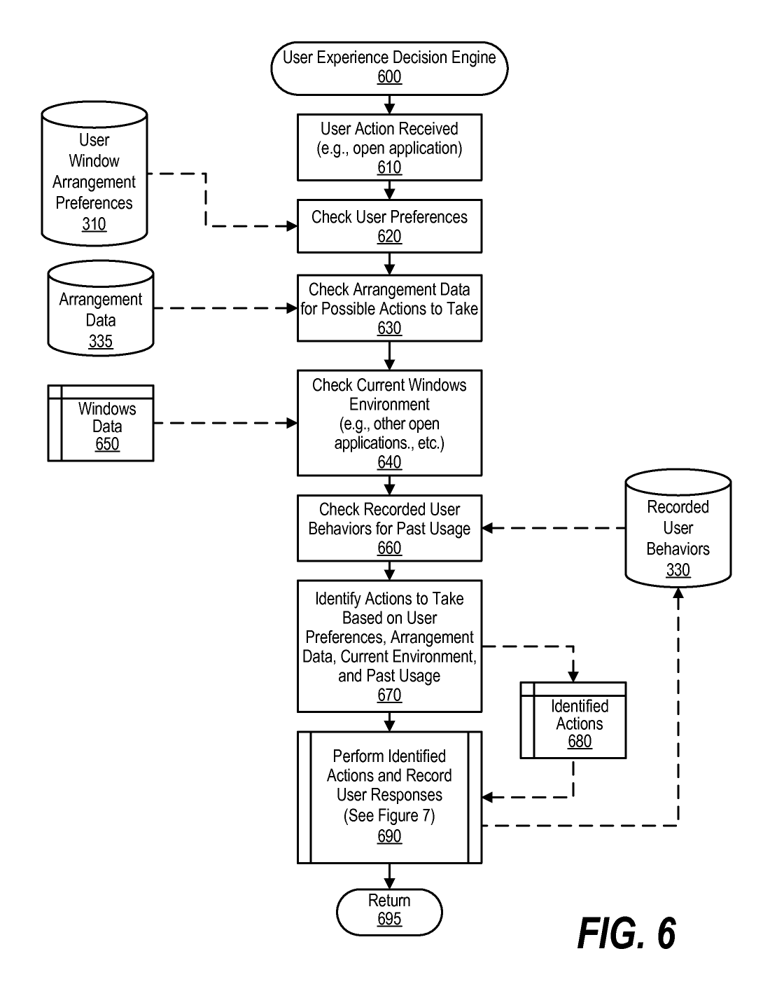

Predefined process 340 is a user experience decision engine that operates to monitor the user's actions with regard to one windowed application and determine which actions, if any, should be performed on one or more other windowed applications based on the user's action. See FIG. 6 and corresponding text for details regarding the operation of the user experience decision engine. The user experience decision engine reads and maintains a record of recorded user behaviors which are stored in data store 330.

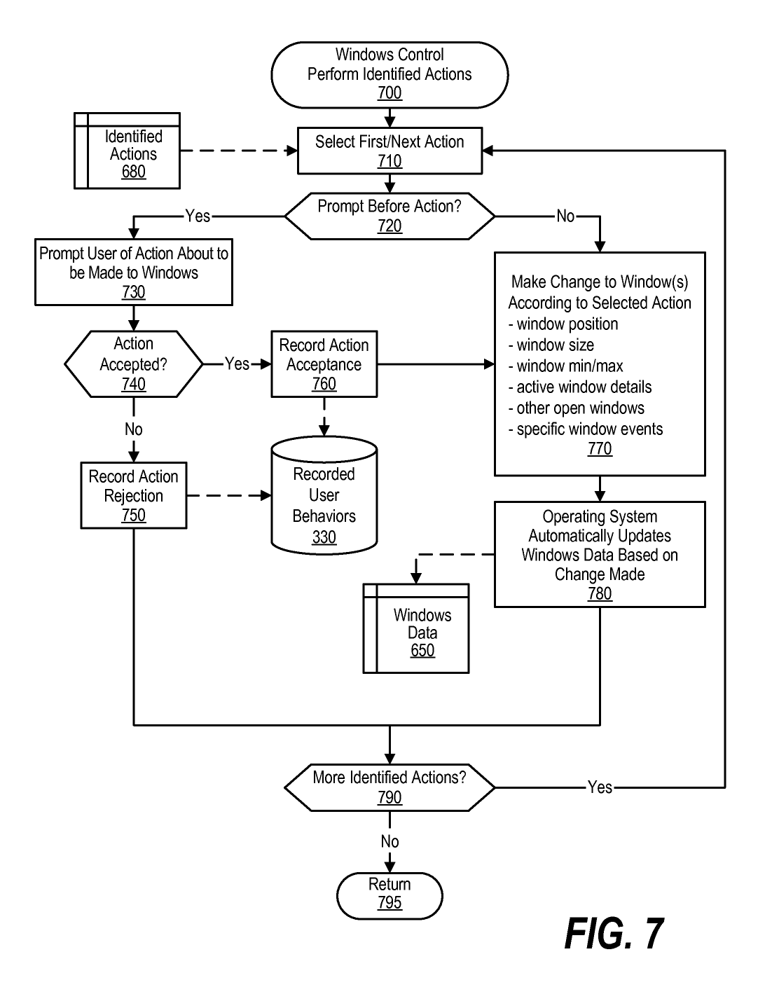

A determination is made as to whether the user has requested user notification prior to performing window actions (decision 350). If the user has requested user notification, then decision 350 branches to the “yes” branch whereupon, at step 360, the user is presented with a notification dialog where the user can select the identified actions that the user would like performed. Using the example from above, when the user opens the email application, a dialog would appear at step 360 which would list the steps about to be performed (e.g., “open calendar application,” “resize email application height,” “resize calendar application height,” “reposition calendar application to left of email application,” etc.). In one embodiment, at step 360 the user can select the actions to be performed (e.g., using checkbox GUI control beside the identified actions, etc.) Returning to decision 350, if user notification has not been requested (the user has requested automatic changes), then decision 350 branches to the “no” branch bypassing step 360. The identified steps (either automatically selected or those confirmed by the user in step 360), are executed in predefined process 370 (see FIG. 7 and corresponding text for processing details). The above processes (predefined processes 320, 340, and 370) continue to operate with each other while the user is utilizing the windowing operating system. Whenever the user would like to edit the way in which the processes, the user can request the operating system to perform user preferences predefined process 300 in order to change the user's preferences that are utilized by the system.

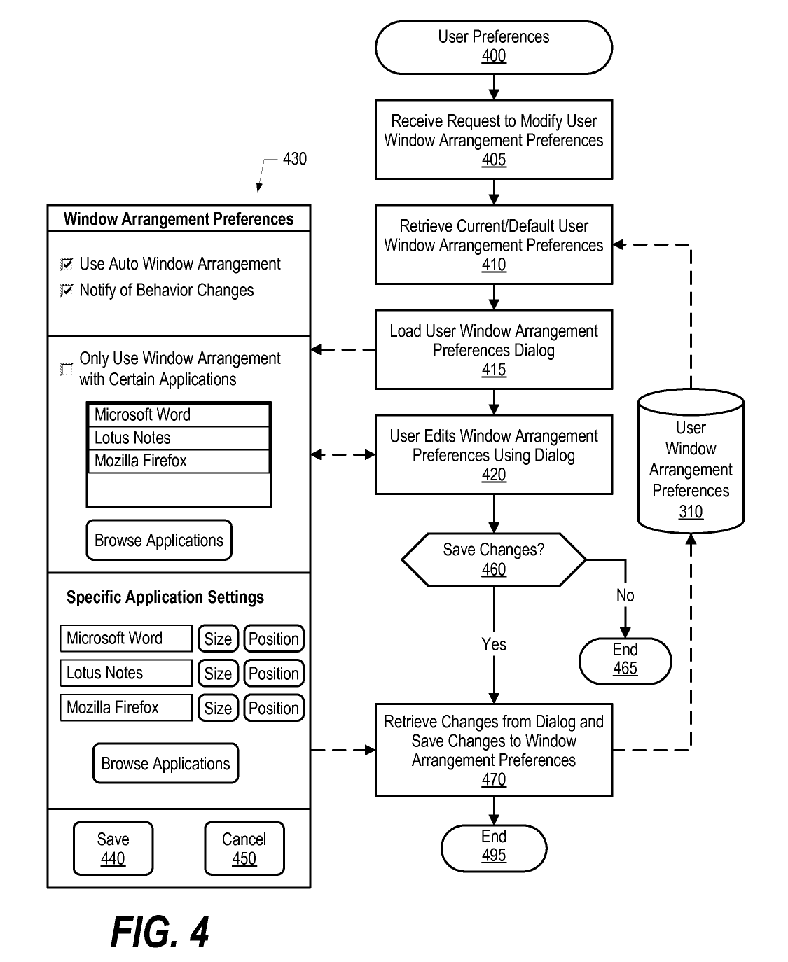

FIG. 4 is a flowchart showing steps taken by the system to manage and record the user's preferences. Processing commences at 400 when the user requests to edit the user preferences at step 405. At step 410, the user preferences process retrieves the current (or default) user window arrangement preferences from data store 310. At step 415, the preferences retrieved in step 410 are loaded in user window arrangement preferences dialog 430. At step 420, the user edits the window arrangement settings using dialog 420.

As shown, many different preferences are available in dialog 420. The “Use Auto Window Arrangement,” checkbox is selected to have the system automatically arrange application windows without notifying the user (see decision 350 and step 360 shown in FIG. 3). The “Notify of Behavior Changes” checkbox is selected to request that the system inform the user when a behavior change is identified. For example, in the email/calendaring applications example introduced in FIG. 3, if the user requested notification and the system thereafter detected the user opening the calendar application after opening the email application and the user resizing the applications and positioning them as previously described, then, if this option is selected, the user would be notified that the system detected these behaviors before recording them in the appropriate data stores.

A checkbox is provided to “Only Use Window Arrangement with Certain Applications,” with a list of the applications. If this option is selected, then the system will only perform automated actions with respect to the listed applications rather than every windowed application used by the user. A command button is provided for the user to browse available applications and have other applications added to the list.

A dialog area is provided for the user to set “Specific Application Settings” which can override user behavior-based actions detected by the system. For example, the user may want the browser to be positioned along the right side of the display with a particular size. If, during the course of using the system, the user moves or resizes the browser, this setting would allow those changes to not be tracked so that the application specific settings would still be in place the next time the user opens the browser. Again, a command button is provided for the user to browse other applications and have other applications added to the list.

When the user is finished editing window arrangement preferences, the user either selects save command button 440 or cancel command button 450. A determination is made as to whether the user requested to save the changes made in dialog 430 by selecting the save command button (decision 460). If the user did not request to save the changes (selected the cancel command button), then decision 460 branches to the “no” branch whereupon processing ends at 465. On the other hand, if the user requested to save the changes by pressing the save command button, then decision 460 branches to the “yes” branch whereupon, at step 470, the options selected in dialog 430 are retrieved and the data is saved to windows arrangement preferences data store 310. Processing thereafter ends at 495.

FIG. 5 is a flowchart showing steps taken monitor the user's behavior. Processing commences at 500 whereupon, at step 510, the user performs an action pertaining to a windowed application managed by the windowing operating system. The action can be almost any action, such as opening a windowed application, re-positioning a window, re-sizing a window, changing a window details, or performing other window actions. At step 520, the user preferences (provided by the user using the steps shown in FIG. 4) are retrieved from user window arrangement preferences data store 310.

At step 525, the first windowed application that is involved in the user action is selected (e.g., the calendar application that was opened after the email application, etc.). A determination is made as to whether the user has requested to only arrange certain windowed applications (decision 530, see FIG. 4, dialog 430 and corresponding text for details). If the user has requested to only automatically arrange certain windowed application, then decision 530 branches to the “yes” branch whereupon a determination is made as to whether the selected application is in the list of the applications that the user has selected for automatic arrangement (decision 540). If the selected application is not in the list, then decision 540 branches to the “no” branch bypassing the remaining steps. However, if either the selected application is in the list (decision 540 branching to the “yes” branch) or if the user has not requested to only auto arrange certain applications (decision 530 branching to the “no” branch), then the selected windowed application is processed.

A determination is made as to whether the user has requested to be notified before the user's behavior based actions are recorded (decision 550). If the user has requested such notification, then decision 550 branches to the “yes” branch whereupon, at step 560, the user is notified of the behavior-based actions that have been detected for the applications involved in the user performed action. At step 560, the user can choose to accept or reject the changes about to be made to the data stores. A determination is made as to whether the user chose to accept or reject the changes (decision 570). If the user rejected the changes, then decision 570 branches to the “yes” branch bypassing steps 580 and 585. On the other hand, if either the user accepted the changes (decision 570 branching to the “no” branch) or the user did not request to be notified of the changes (decision 550 branching to the “no” branch), then, at step 580, the windowed application arrangement data is updated in arrangement data store 335. This arrangement data can include window position, window size, window min/max, active window details, other open windows, and specific window events. At step 585, the user actions that were detected (e.g., the opening of a window, etc.) that related to the updates in the arrangement data are recorded in recorded user behaviors data store 330.

A determination is made as to whether there are more windowed applications involved in the detected user behavior action (decision 590). If more windowed applications are involved, then decision 590 branches to the “yes” branch which loops back to process the next windowed application. This looping continues until each of the windowed applications involved in the detected user behavior action has been processed, at which point decision 590 branches to the “no” branch and processing of the detected user action ends at 595.

FIG. 6 is a flowchart showing steps taken by the user experience decision engine process. Processing commences at 600 whereupon, at step 610, a user action is received, such as opening an email application. At step 620, the user's window arrangement preferences are retrieved from data store 310. At step 630, arrangement data store 335 is checked for possible actions to take. For example, the user may have specified that a windowed application be opened in a particular position and size. At step 640, the current windows operating system environment (windows data 650) is checked for other opened applications, etc. For example, perhaps the email program is moved to the upper right portion of the display whenever the browser windowed application is already opened.

At step 660, recorded user behaviors are retrieved from data store 330. This provides the user's past behaviors with regard to the windowed applications. For example, past behaviors may have been detected where a calendar application is opened by the user when the email program is opened and the calendar is positioned to the left of the email program with both application windows having the same height.

At step 670, actions are identified based on the user's preferences, arrangement data, the current window operating system environment, and the user's past usage (behaviors). These identified actions are stored in memory area 680, such as opening a second windowed application, re-positioning one or more windowed applications, re-sizing or more windowed applications, etc. The identified actions are processed by predefined process 690 (see FIG. 7 and corresponding text for processing details). Processing then returns to the calling routine (see FIG. 3) at 695.

FIG. 7 is a flowchart showing steps to control windows by performing actions identified by the user experience decision engine. This process is called by predefined process 690 shown in FIG. 6. Processing shown in FIG. 7 commences at 700 whereupon, at step 710, the first action identified during the process shown in FIG. 6 is read from memory 680 which lists identified window actions. A determination is made, based upon user preferences read in FIG. 6, as to whether the user wants to be prompted before actions are taken to the displayed windowed applications (decision 720). If the user has requested to be prompted before actions are taken, then decision 720 branches to the “yes” branch whereupon, at step 730, the user is prompted about the selected action that is about to be performed. A determination is made as to whether the user accepts the action (decision 740). If the user rejects the action, then decision 740 branches to the “no” branch whereupon, at step 750, the rejected action is recorded in recorded user behaviors data store 330. Historical user behaviors can be used to determine if actions should be taken, or no longer taken, based upon the user's past acceptance or rejections of such actions. Returning to decision 740, if the user accepts the action, then decision 740 branches to the “yes” branch whereupon, at step 760, the user's acceptance of the action is stored in recorded user behaviors data store 330.

If either the user accepts the action (decision 740 branching to the “yes” branch) or the user has requested to not be prompted before action is taken (decision 720 branching to the “no” branch), then, at step 770 the selected action is performed which results in one or more changes to one or more windowed applications. The changes made to the windowed applications can include altering one or more window positions, altering one or more window sizes, minimizing one or more windows, maximizing one or more windows based, altering window details of one or more windows, launching one or more windowed applications, and performing specific window events to one or more windows. At step 780, the windowing operating system automatically updates windows data 650 based upon the actions taken in step 770.

A determination is made as to whether there are more actions that were identified and stored in memory area 680 (decision 790). If there are more actions, then decision 790 branches to the “yes” branch which loops back to select and process the next action as described above. This looping continues until all of the identified actions stored in memory area 680 have been processed, at which point decision 790 branches to the “no” branch and processing returns to the calling routine (see FIG. 6) at 795.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

One of the implementations of the invention is a client application, namely, a set of instructions (program code) or other functional descriptive material in a code module that may, for example, be resident in the random access memory of the computer. Until required by the computer, the set of instructions may be stored in another computer memory, for example, in a hard disk drive, or in a removable memory such as an optical disk (for eventual use in a CD ROM) or floppy disk (for eventual use in a floppy disk drive). Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps. Functional descriptive material is information that imparts functionality to a machine. Functional descriptive material includes, but is not limited to, computer programs, instructions, rules, facts, definitions of computable functions, objects, and data structures.

While particular embodiments of the present invention have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A computer-implemented method comprising:
receiving a user action directed at a first windowed application executing in a windowing operating system, wherein the first windowed application is displayed on a display using a first set of display attributes;
retrieving one or more user preferences corresponding to the first windowed application in response to receiving the user action, wherein the one or more user preferences reference a second windowed application that runs in the windowed operating system, wherein the second windowed application is displayed on the display using a second set of display attributes;
identifying one or more actions corresponding to the second windowed application based on the retrieved user preferences; and
executing the identified actions on the second windowed application, wherein the executing results in a change to the second set of display attributes resulting in a change in an appearance of the second windowed application.

2. The method of claim 1 wherein the identifying further comprises:
retrieving one or more appearance actions from a data store, wherein the one or more retrieved appearance actions correspond to at least one of the identified actions corresponding to the second windowed application.

3. The method of claim 1 further comprising:
notifying the user that the user action has been received; and
receiving a confirmation from the user prior to recording the one or more identified actions in a data store.

4. The method of claim 1 wherein the user action is received before the second windowed application is being executed by the windowing operating system, the method further comprising:
running the second windowed application in the windowed operating system in response to executing one of the identified actions.

5. The method of claim 1 further comprising:
comparing the first windowed application with a user defined list of windowed applications, wherein the identifying and executing are performed in response to the first windowed application being included in the user defined list of windowed applications.

6. The method of claim 1 further comprising:
comparing the second windowed application with a user defined list of windowed applications, wherein the identifying and executing are performed in response to the second windowed application being included in the user defined list of windowed applications.

7. The method of claim 1 wherein the identified actions are selected from the group consisting of altering the second windowed application window position, altering the second windowed application window size, minimizing the second windowed application window, maximizing the second windowed application window, altering the second windowed application window details, executing the second windowed application, and performing a specific window event in the second windowed application window.

8. The method of claim 1 further comprising:
notifying the user that the identified user actions are about to be performed on the second windowed application; and
receiving a confirmation from the user prior to executing the identified actions.

9. The method of claim 1 wherein the first windowed application and the second windowed application are the same windowed application.

10. An information handling system comprising:
one or more processors;
a memory accessible by at least one of the processors;
a nonvolatile storage medium accessible by at least one of the processors;
a windowing operating system stored on the nonvolatile storage medium and executed by the one or more processors;
a first and a second windowed application stored on the nonvolatile storage medium that are executed by the one or more processors and that run under the windowing operating system;
a display device accessible by at least one of the processors upon which the windowing operating system, the first windowed application, and the second windowed application is displayed; and
a set of instructions stored in the memory and executed by at least one of the processors in order to perform steps of:
receiving a user action directed at the first windowed application, wherein the first windowed application is displayed using a first set of display attributes;
retrieving, from a data store in the nonvolatile storage medium, one or more user preferences corresponding to the first windowed application in response to receiving the user action, wherein the one or more user preferences reference the second windowed application, wherein the second windowed application is displayed using a second set of display attributes;
identifying one or more actions corresponding to the second windowed application based on the retrieved user preferences; and
executing the identified actions on the second windowed application, wherein the executing results in a change to the second set of display attributes resulting in a change in an appearance of the second windowed application.

11. The information handling system of claim 10 wherein the identifying step further comprises:
retrieving one or more appearance actions from a data store, wherein the one or more retrieved appearance actions correspond to at least one of the identified actions corresponding to the second windowed application.

12. The information handling system of claim 10 wherein the steps further comprise:
notifying the user that the user action has been received; and
receiving a confirmation from the user prior to recording the one or more identified actions in a data store.

13. The information handling system of claim 10 wherein the user action is received before the second windowed application is being executed by the windowing operating system, and wherein the steps further comprise:
running the second windowed application in the windowed operating system in response to executing one of the identified actions.

14. The information handling system of claim 10 wherein the steps further comprise:
comparing the first windowed application with a user defined list of windowed applications, wherein the identifying and executing are performed in response to the first windowed application being included in the user defined list of windowed applications.

15. A computer program product stored in a computer readable medium, comprising functional descriptive material that, when executed by an information handling system, causes the information handling system to perform steps comprising:
receiving a user action directed at a first windowed application executing in a windowing operating system, wherein the first windowed application is displayed on a display using a first set of display attributes;
retrieving one or more user preferences corresponding to the first windowed application in response to receiving the user action, wherein the one or more user preferences reference a second windowed application that runs in the windowed operating system, wherein the second windowed application is displayed on the display using a second set of display attributes;
identifying one or more actions corresponding to the second windowed application based on the retrieved user preferences; and
executing the identified actions on the second windowed application, wherein the executing results in a change to the second set of display attributes resulting in a change in an appearance of the second windowed application.

16. The computer program product of claim 15 wherein the identifying step further comprises:
retrieving one or more appearance actions from a data store, wherein the one or more retrieved appearance actions correspond to at least one of the identified actions corresponding to the second windowed application.

17. The computer program product of claim 15 wherein the steps further comprise:
notifying the user that the user action has been received; and
receiving a confirmation from the user prior to recording the one or more identified actions in a data store.

18. The computer program product of claim 15 wherein the user action is received before the second windowed application is being executed by the windowing operating system, and wherein the steps further comprise:
running the second windowed application in the windowed operating system in response to executing one of the identified actions.

19. The computer program product of claim 15 wherein the steps further comprise:
comparing the first windowed application with a user defined list of windowed applications, wherein the identifying and executing are performed in response to the first windowed application being included in the user defined list of windowed applications.

20. The computer program product of claim 15 wherein the steps further comprise:
notifying the user that the identified user actions are about to be performed on the second windowed application; and
receiving a confirmation from the user prior to executing the identified actions.
